(19) United States
(12) Patent Application Publication
(10) Pub. No.: US 2014/0137757 A1
(43) Pub. Date: May 22, 2014

(54) AGRICULTURAL IMPLEMENT WITH POWER INPUT HAVING CONTINUOUSLY VARIABLE TRANSMISSION

(71) Applicant: AGCO Corporation, Duluth, GA (US)

(72) Inventors: Darren J. Nelson, Hutchinson, KS (US); Robert A. Matousek, Valley Center, KS (US)

(73) Assignee: AGCO Corporation, Duluth, GA (US)

(21) Appl. No.: 14/083,778

(22) Filed: Nov. 19, 2013

Related U.S. Application Data
(60) Provisional application No. 61/727,903, filed on Nov. 19, 2012.

(51) Int. Cl. A01F 15/08

(52) U.S. Cl. CPC A01F 15/0841
USPC 100/102

(57) ABSTRACT

A crop baler has a plunger reciprocable through compression and retraction strokes for compressing charges of crop material into bales within the baler. The crop baler also includes a rotatable flywheel operably coupled with the plunger for transferring kinetic energy to the plunger during reciprocation of the plunger. An output shaft is operably coupled with the flywheel for rotating the flywheel and driving the plunger through its compression and retraction strokes and an input shaft is adapted to be coupled with a power takeoff shaft of a towing tractor for receiving driving power from the tractor. The crop baler also includes a continuously variable transmission operably coupled between the input and output shafts for adjusting the ratio of the angular velocities of the shafts in response to changes in the angular velocity of the flywheel while maintaining the input shaft at a substantially constant angular velocity.

### CROSS REFERENCE TO RELATED APPLICATION

This application claims the benefit of U.S. Provisional Application No. 61/727,903, entitled AGRICULTURAL IMPLEMENT WITH POWER INPUT HAVING CONTINUOUSLY VARIABLE TRANSMISSION filed Nov. 19, 2012, which is hereby incorporated by reference in its entirety.

### BACKGROUND OF THE INVENTION

1. Field of Invention

This invention relates to mobile crop balers of the type wherein a reciprocating plunger is used to compact crop materials within a baling chamber of the machine and power for driving the plunger is transmitted from the power take-off (PTO) shaft of the towing tractor by a mechanical drive line that includes a large, heavy flywheel, and more particularly, the invention relates to improvements in that drive line.

2. Description of Related Art

Mechanically driven large square balers typically use a large, heavy flywheel to store energy from the tractor. During baling operations, the flywheel speed decreases during compression strokes of the plunger as the energy is transmitted to the forming bale by the plunger. As the flywheel slows, the tractor engine's load is increased, which slows the PTO shaft. As the flywheel regains speed following completion of the compression stroke, the tractor engine's load decreases, which increases the PTO shaft speed.

This cyclic loading can cause excessive wear to components of the drive line, the tractor's PTO shaft, and the engine of the tractor. Moreover, the flywheel's top speed and corresponding peak energy are limited by the engine's top speed, not its maximum power.

### OVERVIEW OF THE INVENTION

In one embodiment, the invention is directed to a continuously variable transmission in the drive line on the baler ahead of the flywheel which is capable of maintaining the tractor engine PTO shaft speed and engine power nearly constant throughout baling operations while varying the speed of the flywheel in accordance with the fluctuating energy demands of the reciprocating plunger as it forms a bale within the bale chamber. The continuously variable transmission is operable to overspeed the flywheel during the plunger's retraction stroke to store additional energy that is transmitted to the forming bale during the next compression stroke. A controller forming a part of the transmission receives inputs regarding tractor engine speed, engine power and baler flywheel speed to adjust the ratio of angular velocities of an input drive line shaft to the transmission from the PTO and an output drive line shaft from the transmission to the flywheel, thus effectively determining optimum power and maximum flywheel speed based on baler load.

In another embodiment, the invention is directed toward a crop baler having a plunger reciprocable through compression and retraction strokes for compressing charges of crop material into bales within the baler. The crop baler also includes a rotatable flywheel operably coupled with the plunger for transferring kinetic energy to the plunger during reciprocation of the plunger. An output shaft is operably coupled with the flywheel for rotating the flywheel and driving the plunger through its compression and retraction strokes and an input shaft is adapted to be coupled with a power takeoff shaft of a towing tractor for receiving driving power from the tractor. The crop baler also includes a continuously variable transmission operably coupled between the input and output shafts for adjusting the ratio of the angular velocities of the shafts in response to changes in the angular velocity of the flywheel while maintaining the input shaft at a substantially constant angular velocity.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic side elevational view of a tractor and baler combination employing a continuously variable transmission in accordance with the principles of the present invention; and

FIG. 2 is a diagram illustrating how the controller of the transmission receives input information regarding flywheel speed, tractor engine speed, and engine power to establish the ratio for input and output drive line shaft velocities on opposite sides of the transmission.

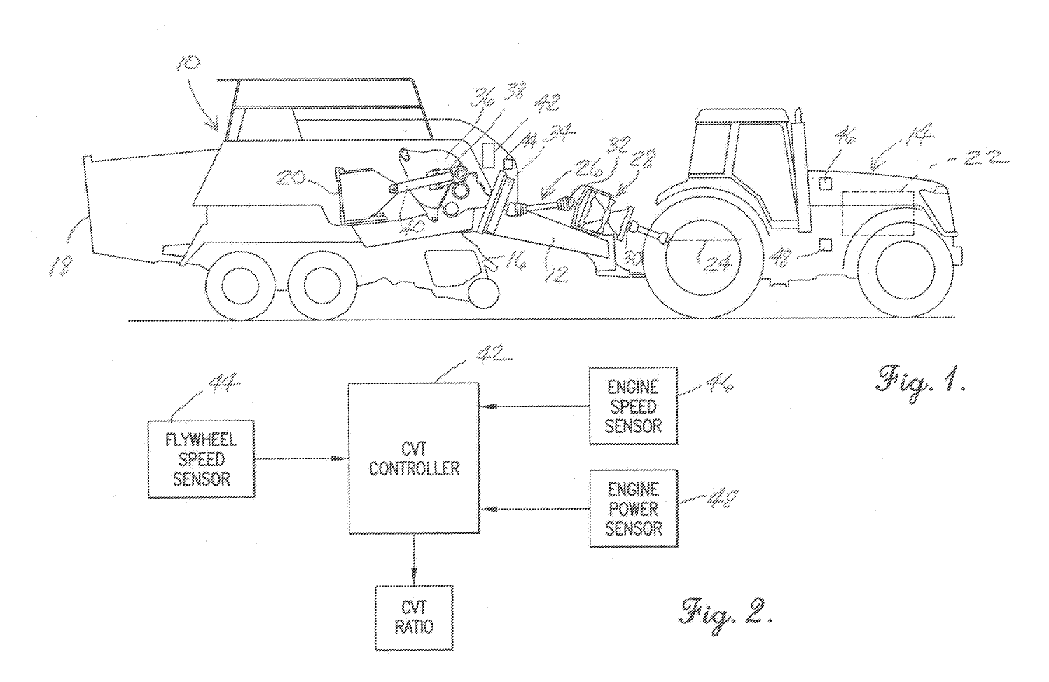

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

A mobile baler 10 may advantageously comprise a Large Rectangular Baler of the type manufactured and sold for many years by AGCO Corporation of Duluth, Georgia under the HESSTON and MASSEY-FERGUSON brand names, for example. Balers of this type are generally disclosed in U.S. Pat. Nos. 5,226,356; 5,540,144; and 7,448,196, for example, which patents are hereby incorporated by reference in their entireties into the present specification for a further understanding of the nature and operation of the baler 10.

For purposes of the present invention, suffice it to point out that baler 10 includes a wheeled chassis having a forwardly projecting tongue 12 that adapts the baler to be hitched to a towing tractor 14 for traversing a field having windrowed crop materials lying thereon. A pickup 16 lifts such materials off the ground as the baler advances and, in cooperation with other mechanism not shown, delivers the materials in successive charges to packaging apparatus within the baler for forming the materials into large “rectangular” bales that issue from the open, but constricted, rear end 18 of the baler. Among other things, the packaging apparatus includes a reciprocating plunger 20 that operates within a baling chamber of the machine to compact successively introduced charges of crop materials rearwardly against previously compacted materials to build a bale and incrementally push it toward and through the open rear end 18 of the baler.

Power for operating plunger 20 is obtained from an engine 22 of the tractor 14 via a PTO shaft 24. A drive train on baler 10 for transmitting power from tractor engine 22 to plunger 20 is broadly denoted by the numeral 26 and connects at its forward end to PTO shaft 24 for receiving operating power therefrom. Drive train 26 includes, in relevant part, a continuously variable transmission 28, an input shaft 30 operably coupled at its front end to PTO shaft 24 and at its rear end to transmission 28, an output shaft 32 operably coupled at its front end to transmission 28, and a large, heavy flywheel 34 operably coupled to the rear end of output shaft 32 and rotated thereby. Drive train 26 further includes a gear box 36 that receives rotational input from flywheel 34, a pair of output cranks 38 (only one being shown) on opposite sides of gear box 36, and a pair of pitman rods 40 (only one being shown) connected at their front ends with cranks 38. Pitman rods 40 are operably coupled at their rear ends with plunger 20.

Although continuously variable transmission 28 may take a variety of different forms without departing from the principles of the present invention, one suitable transmission is a toroidal type continuously variable transmission available from CVT Corporation of Sainte-Julie (QC) Canada. In addition to various mechanical components, transmission 28 also includes a control system that includes a suitable programmable controller 42 that renders transmission 28 capable of very quickly adjusting the ratio of the angular velocities of input and output shafts 30, 32 to maintain a substantially constant angular velocity on the input shaft 30 and PTO shaft 24 notwithstanding fluctuations in the angular velocity of the flywheel 34 due to loading. Controller 42 may be software, hardware, and/or firmware and configured to determine and regulate the ratio of the velocities of input and output shafts 30, 32. Preferably, controller 42 is located on baler 10 but could comprise part of a unit mounted on tractor 14 having a display and an operator interface.

A number of suitable sensors, such as a flywheel speed sensor 44, an engine speed sensor 46, and an engine power sensor 48 are provided for inputting information into controller 42 for use in determining the appropriate relative velocities of input shaft 30 and output shaft 32. Controller 42 receives the input signals, quickly processes the information to determine the appropriate shaft ratios, and quickly outputs appropriate commands for adjusting the angular velocity of output shaft 32 while maintaining the velocity of input shaft 30 substantially constant.

It will be appreciated that as a result of having the continuously variable transmission 28 installed in drive train 26 between tractor PTO shaft 24 and flywheel 34, nearly constant tractor engine speed and power can be realized while providing variable speed output to flywheel 34. Transmission 28 is able to overspeed flywheel 34 during the plunger retraction stroke to store additional energy for the next compression stroke. By quickly adjusting the output velocity of transmission 28 while maintaining the input velocity substantially constant, cyclic loading of the tractor engine and related components can be significantly reduced, and the flywheel's top speed and corresponding peak energy are limited by the tractor engine's maximum power, not its top speed.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A crop baler comprising:
a plunger reciprocable through compression and retraction strokes for compressing charges of crop material into bales within the baler;
a rotatable flywheel operably coupled with the plunger for transferring kinetic energy to the plunger during reciprocation of the plunger;
an output shaft operably coupled with the flywheel for rotating the flywheel and driving the plunger through its compression and retraction strokes;
an input shaft adapted to be coupled with a power takeoff shaft of a towing tractor for receiving driving power from the tractor; and
a continuously variable transmission operably coupled between the input and output shafts for adjusting the ratio of the angular velocities of the shafts in response to changes in the angular velocity of the flywheel while maintaining the input shaft at a substantially constant angular velocity.

2. A crop baler as claimed in claim 1, wherein said continuously variable transmission is operable to increase the angular velocity of the flywheel during retraction strokes of the plunger.

3. A crop baler as claimed in claim 1, wherein said continuously variable transmission includes a controller operable to receive and process input signals regarding flywheel velocity, tractor engine speed, and tractor engine power and to output commands for adjusting the ratios of the angular velocities of the input and output shafts.

4. A crop baler as claimed in claim 3, wherein said continuously variable transmission is operable to increase the angular velocity of the flywheel during retraction strokes of the plunger.

5. A crop baler as claimed in claim 1, wherein said continuously variable transmission comprises a toroidal type continuously variable transmission.
